(19) United States
(12) Patent Application Publication
(10) Pub. No.: US 2006/0068337 A1
(43) Pub. Date: Mar. 30, 2006

(54) Substrate processing method

(75) Inventors: Keiji Tanouchi, Yamanashi (JP); Satoru Shimura, Yamanashi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 11/218,637

(22) Filed: Sep. 6, 2005

(30) Foreign Application Priority Data
Sep. 9, 2004 (JP) 2004-262248

(51) Int. Cl. G03C 5/26

(52) U.S. Cl. 430/464

(57) ABSTRACT

In the present invention, a substrate processing method, in which a developing treatment is performed after exposure processing of a pattern, includes a shaping step of shaping the shape of a resist pattern such that a side wall portion of the resist pattern after the developing treatment swells out to a groove side and a swell-out portion swelling out to the groove side and concavely curving with respect to the groove side is formed at a corner portion of a bottom of the resist pattern. According to the present invention, the side wall portion is made to swell out to improve the striation of the resist pattern, resulting in a preferable shape of a pattern after etching treatment.

### BACKGROUND OF THE INVENTION

1. Field of the Invention

The present invention relates to a substrate processing method.

2. Description of the Related Art

In a photolithography process in a manufacturing process of a semiconductor device, for example, resist coating treatment in which a resist solution is applied on a base film of a semiconductor wafer (hereinafter, referred to as a “wafer”) to form a resist film, exposure processing in which a predetermined pattern is exposed on the wafer, developing treatment in which the wafer after exposure is developed, etching treatment in which the base film or the like on the wafer is etched, and so on are performed, so that a predetermined circuit pattern is formed on the wafer.

In the aforementioned exposure processing, light is applied to a predetermined portion of the flat resist film to change the solubility of the exposed portion to a developing solution. In the developing treatment, when the developing solution is supplied to the wafer, the resist film at the exposed portion is selectively dissolved and removed, if it is, for example, a positive-type resist, resulting in a desired resist pattern formed on the wafer (see Japanese Patent Application Laid-open No. 2002-75854). In the etching treatment, the base film being a lower layer is selectively etched with the resist film in the aforementioned pattern functioning as a mask.

Incidentally, on the surface of the resist film which has been subjected to the aforementioned developing treatment, for example, a plurality of lines L may appear on the side wall surface of the resist pattern (mask pattern) as shown in FIG. 13, resulting in projections and depressions (striations) on the surface of the resist film R. This is conceivably caused by the wave property of light applied from above the wafer during exposure processing. Further, the LER (Line Edge Roughness) of the pattern is also high.

The appearance of projections and depressions on the surface of the resist film roughens the surface and increases the value of LER, so that when the resist film is used as a mask to perform etching treatment for the base film, for example, projections and depressions corresponding to the lines L on the resist film appear on the base film. As a result of the appearance of projections and depressions on the surface of the base film due to the formation of lines, no precise circuit pattern may be formed on the wafer, thereby resulting in the failure to manufacture a semiconductor device with a desired quality. Particularly, in these days when the circuit pattern has been made finer, even slight projections and depressions greatly affect the shape of the circuit pattern, and therefore it is desired to improve such a kind of “roughness” on the surface of the resist pattern.

### SUMMARY OF THE INVENTION

The present invention has been developed in consideration of the above point and its object is to improve the above-described striation and LER of the resist pattern in a substrate processing method in which a developing treatment is performed after exposure processing of a resist pattern formed on a substrate such as a wafer.

To achieve the above object, the present invention includes a step of supplying a developing solution to a substrate which has been subjected to exposure processing of a pattern; and a shaping step of shaping the shape of a resist pattern such that a side wall portion of the resist pattern after the developing treatment swells out to a groove side and a swell-out portion swelling out to the groove side and concavely curving with respect to the groove side is formed at a corner portion of a bottom of the resist pattern.

Such shaping may be performed, for example, by swelling a resist film; by mixing a surfactant or a liquid made by diluting the surfactant into the cleaning solution accumulated on the substrate, after cleaning the developing solution supplied to the substrate during the developing treatment; by gradually replacing the cleaning solution accumulated on the substrate with a liquid made by diluting the surfactant, after cleaning the developing solution supplied to the substrate during the developing treatment; or by dissolving a resist film. The dissolving the resist film may be performed, for example, by exposing the substrate to a vapor atmosphere of a solvent dissolving the resist film or by supplying a solvent dissolving the resist film to the substrate. To expose the substrate to the vapor atmosphere of the solvent, for example, a gas containing the solvent vapor may be supplied to the substrate, or the solvent vapor may be supplied into a container housing the substrate.

According to the present invention, it is possible to improve the striation and LER of the resist pattern before etching.

### BRIEF DESCRIPTION OF THE DRAWINGS

FIG. 1 is a plan view showing the outline of a configuration of a coating and developing treatment system incorporating a developing treatment unit for implementing the embodiment;

FIG. 2 is a front view of the coating and developing treatment system in FIG. 1;

FIG. 3 is a rear view of the coating and developing treatment system in FIG. 1;

FIG. 4 is an explanatory view of a longitudinal section of the developing treatment unit;

FIG. 5 is an explanatory view of a transverse section of the developing treatment unit;

FIG. 6 is a flowchart showing a part of a processing process of a wafer;

FIG. 7 is a side sectional view showing the state of a resist pattern after developing treatment;

FIG. 8 is a side sectional view showing the state of a resist pattern after a shaping step is finished;

FIG. 9 is a side sectional view showing the state of a pattern after an anti-reflection film is etched;

FIG. 10 is a side sectional view showing the state of a pattern after a TEOS oxide film is etched;

FIG. 11 is a side sectional view showing the state of a pattern after a base film is etched;

FIG. 12 is a perspective view of a solvent vapor supply nozzle; and

FIG. 13 is an explanatory view showing projections and depressions on a surface of a resist film after conventional developing treatment.

### DETAILED DESCRIPTION OF THE INVENTION

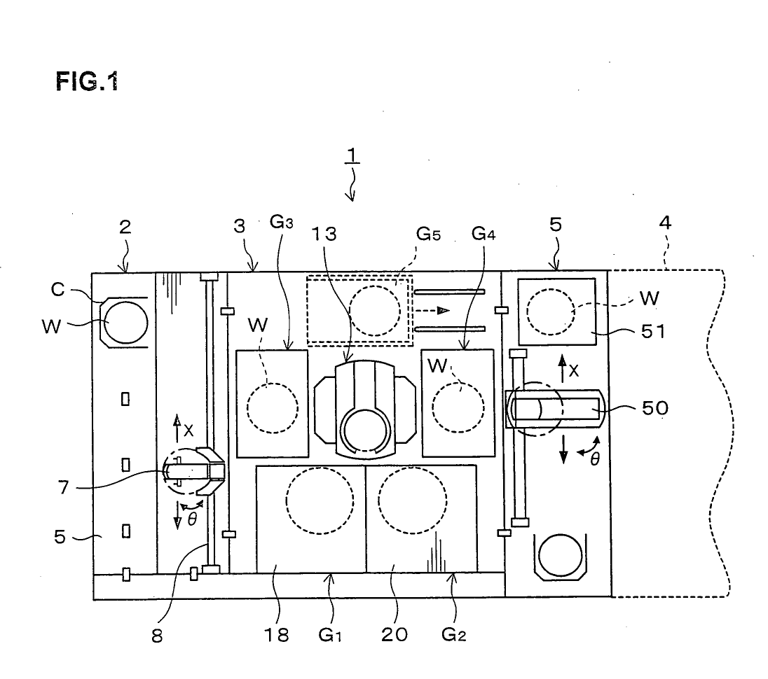

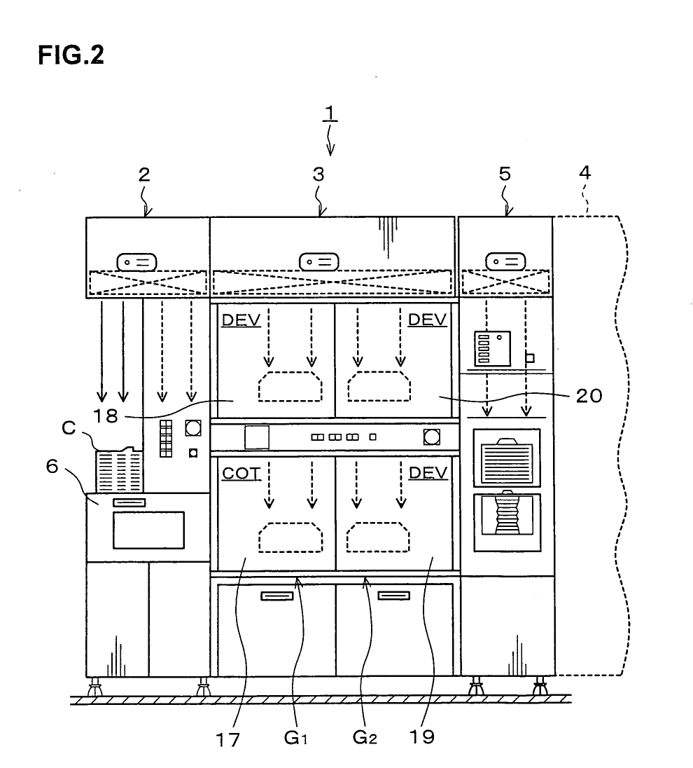

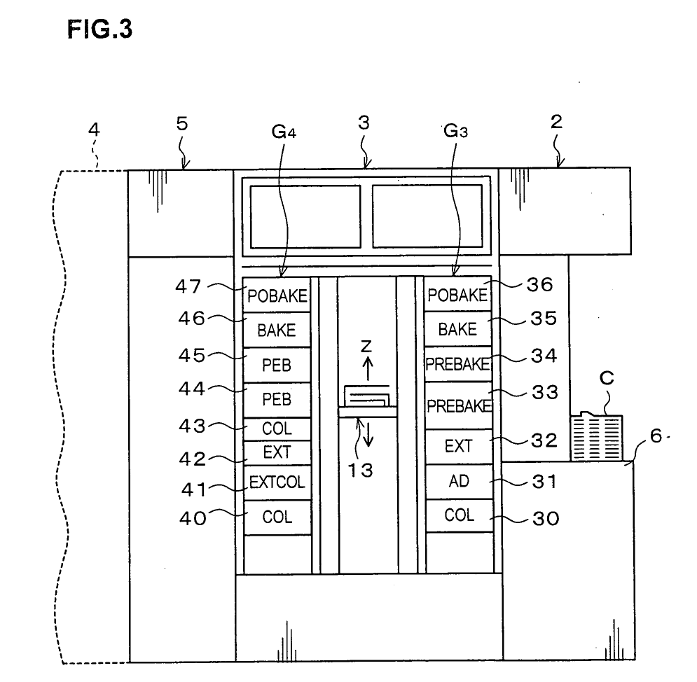

Hereinafter, a preferred embodiment of the present invention will be described. FIG. 1 is a plan view showing the outline of a configuration of a coating and developing treatment system 1 incorporating a developing treatment unit for implementing the embodiment, FIG. 2 is a front view of the coating and developing treatment system 1, and FIG. 3 is a rear view of the coating and developing treatment system 1.

The coating and developing treatment system 1 has, as shown in FIG. 1, a configuration in which, for example, a cassette station 2 for carrying, for example, 25 wafers per cassette as a unit from/to the outside into/from the coating and developing treatment system 1 and carrying the wafers W into/out of the cassette C; a processing station 3 including various kinds of processing and treatment units, which are multi-tiered, for performing predetermined processing or treatments in a manner of single wafer processing in coating and developing treatment processes; and an interface section 5 for transferring the wafers W to/from an aligner 4 provided adjacent to the processing station 3, are integrally connected together.

In the cassette station 2, a plurality of cassettes C can be mounted at predetermined positions on a cassette mounting table 6 being a mounting section in a line in an X-direction (a top-to-bottom direction in FIG. 1). A wafer carrier 7, which is movable in a cassette-arrangement direction (the X-direction) and in a wafer-arrangement direction of the wafers W housed in the cassette C (a Z-direction; the vertical direction), is further provided along a carrier path 8 and thus can selectively access the cassettes C.

The wafer carrier 7 includes an alignment function of aligning the wafer W. The wafer carrier 7 is configured, as described later, to be able to also access an extension unit 32 included in a third processing unit group G3 on the processing station 3 side.

In the processing station 3, a main carrier unit 13 is provided at its central portion, and various kinds of processing and treatment units are multi-tiered to constitute processing unit groups around the main carrier unit 13. In this coating and developing treatment system 1, four processing unit groups G1, G2, G3, and G4 are arranged. The first and second processing unit groups G1 and G2 are placed on the front side of the coating and developing treatment system 1, the third processing unit group G3 is placed adjacent to the cassette station 2, and the fourth processing unit group G4 is placed adjacent to the interface section 5. Further, as an option, a fifth processing unit group G5 shown by a broken line can be separately placed on the rear side of the coating and developing treatment system 1. The main carrier unit 13 can carry the wafer W to the later-described various kinds of processing and treatment units located in these processing unit groups G1, G2, G3, G4, and G5. Note that the number and arrangement of the processing unit groups can be arbitrarily selected depending on the kind of processing to be performed on the wafer W.

In the first processing unit group G1, as shown in FIG. 2, for example, a resist coating unit 17 for applying a resist solution to the wafer W to form a resist film on the wafer W and a developing treatment unit 18 for developing the wafer W are two-tiered in order from the bottom. In the second processing unit group G2, developing treatment units 19 and 20 are two-tiered in order from the bottom.

In the third processing unit group G3, as shown in FIG. 3, for example, a cooling unit 30 for cooling the wafer W, an adhesion unit 31 for enhancing adhesion between the resist solution and the wafer W, the extension unit 32 for transferring the wafer W, pre-baking units 33 and 34 each for evaporating the solvent in the resist solution, a heating unit 35 for heating the wafer W, and a post-baking unit 36 for performing heating processing after the developing treatment are, for example, seven-tiered in order from the bottom.

In the fourth processing unit group G4, for example, a cooling unit 40, an extension and cooling unit 41 for allowing the wafer W mounted thereon to naturally cool, an extension unit 42, a cooling unit 43, post-exposure baking units 44 and 45 each for performing heating processing after exposure, a heating unit 46, and a post-baking unit 47 are, for example, eight-tiered in order from the bottom.

At the center portion of the interface section 5, for example, a wafer carrier 50 is provided as shown in FIG. 1. The wafer carrier 50 is configured to be movable in the X-direction (the top-to-bottom direction in FIG. 1) and the Z-direction (the vertical direction) and also freely rotatable in a θ-direction (a direction of rotation around the X-axis). The wafer carrier 50 can access the extension and cooling unit 41, the extension unit 42, and an edge exposure unit 51 included in the fourth processing unit group G4 and the aligner 4 and carry the wafer W to each of them.

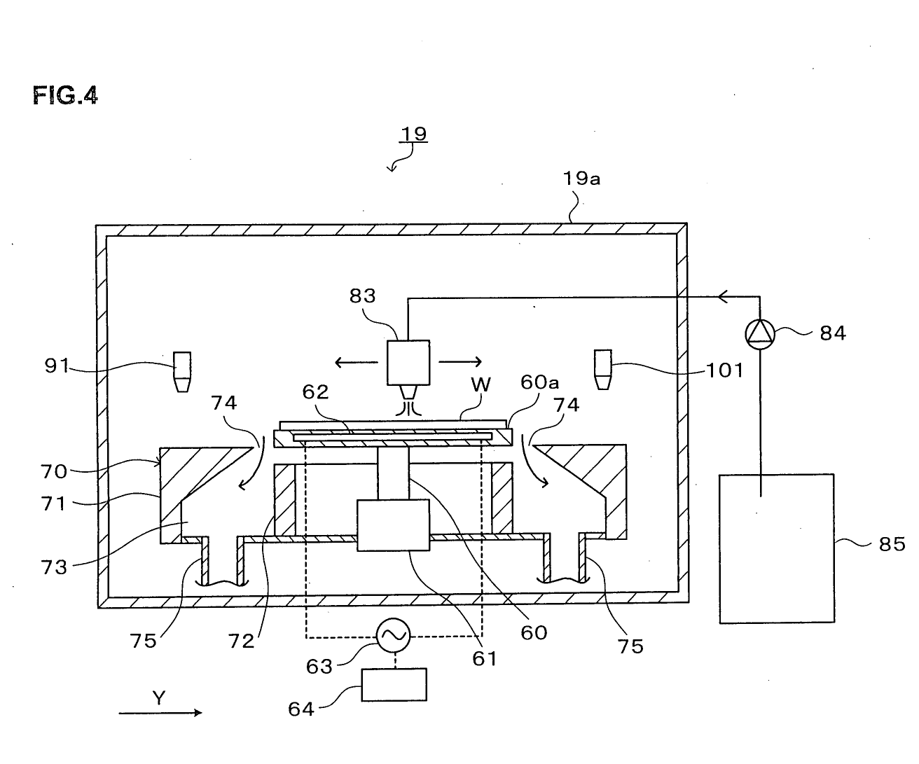

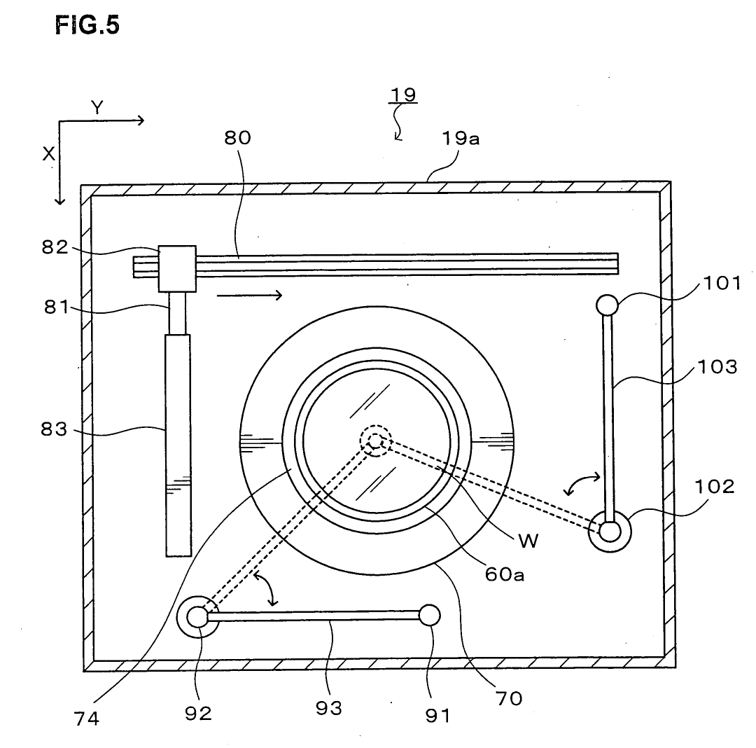

Next, the configuration of the developing treatment unit 19 will be described. The developing treatment unit 20 has the same configuration as that of the developing treatment unit 19. As shown in FIGS. 4 and 5, at the center portion in a casing 19a of the developing treatment unit 19, a chuck 60 for holding the wafer W thereon is provided. A holding surface 60a being the upper face of the chuck 60 is formed in a circle having a diameter slightly larger than the diameter of the wafer W. The holding surface 60a is provided with a not-shown plurality of suction holes so that suction through the suction holes can suck the wafer W onto the holding surface 60a. The chuck 60 is provided with a raising and lowering drive unit 61 such as a cylinder which can move the holding surface 60a of the chuck 60 up and down to deliver the wafer W to/from the main carrier unit 13.

A temperature regulator 62 is built in the holding surface 60a of the chuck 60 and can bring the temperature of the wafer on the holding surface 60a to a predetermined temperature. The temperature regulator 62 operates by feed of power from a power supply 63 and is controlled by a temperature controller 64.

Around the chuck 60, for example, an exhaust cup 70 for exhausting gas is provided. The exhaust cup 70 is located, for example, below the holding surface 60a of the chuck 60. The exhaust cup 70 has a double structure composed of, for example, an outer cup 71 and an inner cup 72 which are cylindrical, and an exhaust path 73 is formed between the outer cup 71 and the inner cup 72. In the clearance between top ends of the outer cup 71 and the inner cup 72, an annular suction port 74 is formed and disposed along the periphery of the holding surface 60a as shown in FIG. 5. To the clearance between bottom ends of the outer cup 71 and the inner cup 72, an exhaust pipe 75 is connected which leads to an exhauster (not shown) located outside the developing treatment unit 19 and can exhaust the atmosphere in the vicinity of the chuck 60 through the suction port 74 as necessary.

As shown in FIG. 5, on one side of the exhaust cup 70, a rail 80 is provided along a Y-direction (a right-to-left direction in FIG. 5). The rail 80 is provided, for example, from the outside on one end side of the exhaust cup 70 to the outside on the other end side.

On the rail 80, one end portion of an arm 81 is supported which is freely movable on the rail 80 by means of a drive unit 82. On the arm 81, a developing solution supply nozzle 83 is held which supplies a developing solution onto the wafer W. Accordingly, the developing solution supply nozzle 83 can move along the rail 80 from the outside on the one end side of the exhaust cup 70, passing over the chuck 60, to the outside on the other end side of the exhaust cup 70. To the developing solution supply nozzle 83, a developing solution from a developing solution supply source 85 is supplied by a pump 84.

Further, in the casing 19a of the developing treatment unit 19, a cleaning nozzle 91 is provided which supplies a cleaning solution, for example, pure water to the wafer W. The cleaning nozzle 91 is attached to one end portion of an arm 93 supported by a rotary drive unit 92 and can turn and move to a position above the center of the wafer W.

Furthermore, in the casing 19a of the developing treatment unit 19, a supply nozzle 101 is provided which supplies a surfactant having an action of causing the resist to swell, for example, a solution made by diluting a nonionic hydrocarbon compound. The supply nozzle 101 is attached to one end portion of an arm 103 supported by a rotary drive unit 102 and can turn and move to the position above the center of the wafer W.

The developing treatment unit 19 has the above-described configuration. Next, processing process in the coating and developing treatment system 1 will be described. For this embodiment, the process is described based on an example of a wafer having a base film formed thereon made of polysilicon, a TEOS oxide film formed on the base film, and a BARC (a bottom anti-reflection film) formed on the TEOS oxide film, the wafer being then formed with a resist film in a later-described process and thereafter subjected to exposure processing and developing treatment.

First, one unprocessed wafer W is taken out of the cassette C by the wafer carrier 7 and carried to the extension unit 32 included in the third processing unit group G3. The wafer is then carried by the main carrier unit 13 into the adhesion unit 31 where, for example, HMDS for enhancing adhesion of the resist solution is applied to the wafer W. The wafer W is then carried to the cooling unit 30 to be cooled to a predetermined temperature, and thereafter carried to the resist coating unit 17. In the resist coating unit 17, the resist solution is applied onto the wafer W to form a resist film. In this embodiment, a KrF resist is used as the material of the resist solution. In addition, an ArF resist is also applicable.

The wafer W formed with the resist film thereon is carried by the main carrier unit 13 to the pre-baking unit 33 and the extension and cooling unit 41 in order, and carried by the wafer carrier 50 to the edge exposure unit 51 and the aligner 4 in order so that the wafer W is subjected to predetermined processing or treatment in each of the units. The wafer W for which exposure processing has been finished in the aligner 4 is carried by the wafer carrier 50 to the extension unit 42, then subjected to predetermined processing in the post-exposure baking unit 44 and the cooling unit 43, and thereafter carried to the developing treatment unit 19 where the wafer W is subjected to developing treatment.

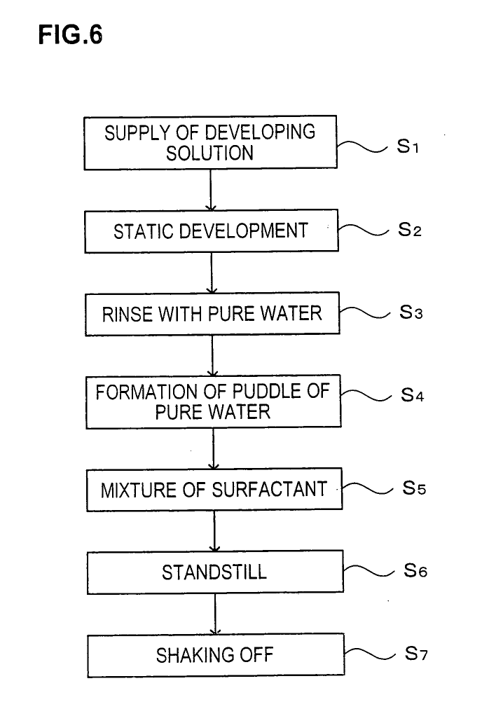

Hereinafter, describing the processing process based on the flow shown in FIG. 6, a developing solution is first supplied onto the wafer W by the developing solution supply nozzle 83 (Step S1). An accumulation (puddle) of the developing solution is then formed on the wafer W, and thereafter the wafer W is kept in a standstill state for a predetermined period for static development (Step S2). After a lapse of the predetermined period, the cleaning nozzle 91 moves to the position above the center of the wafer W and supplies a cleaning solution, for example, pure water onto the wafer W, while the wafer W is simultaneously rotated by the rotation of the chuck 60, thereby rinsing away the developing solution on the wafer W (Step S3).

Subsequently, the chuck 60 is stopped to bring the wafer W into a standstill and, in that state, a puddle of the cleaning solution, for example, pure water is formed this time, or pure water is accumulated on the wafer W (Step S4).

Thereafter, the supply nozzle 101 moves this time to the position above the center of the wafer W and supplies the diluted surfactant onto the wafer W (Step S5). In this case, the diluted surfactant may be partially mixed into the puddle of pure water, or may be gradually mixed into the pure water so that the puddle of pure water is replaced with the liquid of the diluted surfactant.

In any case, in that state, namely, the state in which the surfactant is mixed into the puddle of pure water or the state in which the puddle of pure water is replaced with the diluted surfactant, the wafer W is kept standstill (Step S6). From the state in which the active component in the surfactant is in contact with the resist pattern after the developing treatment, a shaping step of the present invention is started.

After a lapse of a predetermined period, the chuck 60 is rotated to shake off the liquid having the surfactant component on the wafer W (Step S7).

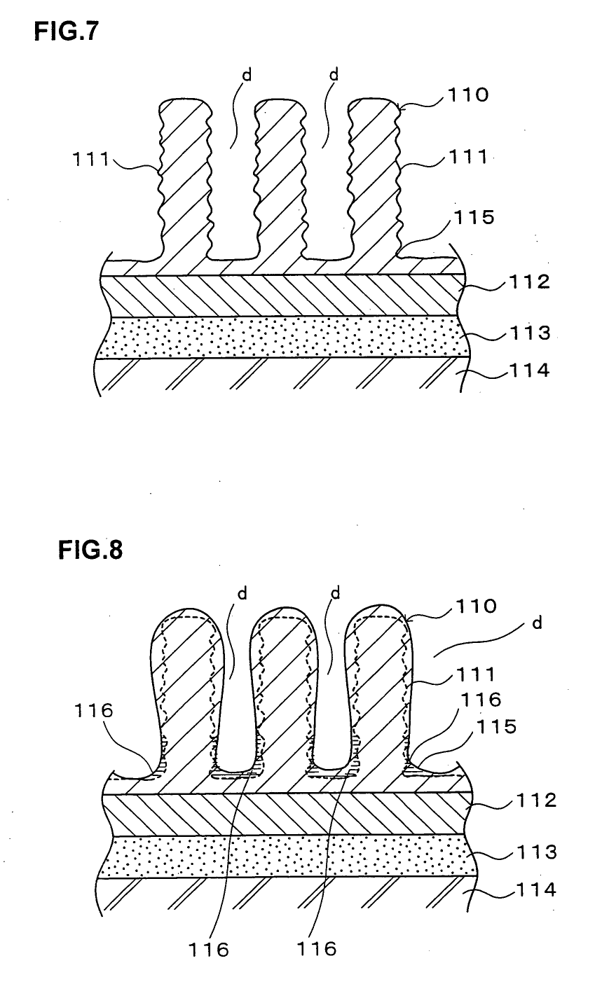

In the above-described process, at the point in time when the static development (Step S2) is finished, projections and depressions appear on side wall portions 111 of a resist pattern 110 as shown in FIG. 7. Note that a numeral 112 denotes an anti-reflection film, a numeral 113 denotes a TEOS oxide film, and a numeral 114 denotes a polysilicon layer as the base film. Further, corner portions 115 at the bottom of the resist pattern 110 are formed at almost right angles.

However, after a lapse of a predetermined period after supply of the diluted surfactant onto the wafer surface according to the present invention, namely, at the point in time when the shaping step being Step S6 is finished, the side wall portions 111 of the resist pattern 110 have swelled out to the side of grooves d so that the above-described projections and depressions have disappeared. In addition, at the corner portions 115 at the bottom of the resist pattern 110, swell-out portions 116 are formed which swell out to the side of the groves d and concavely curve with respect to the side of the grooves d. It is considerable that such shaping is carried out by the side wall portions 111 swelling out due to the dissolving action of the surfactant.

The resist pattern shaped in such a manner results in a preferably shaped pattern at the point in time when the etching treatment being a post processing is finished. The results of the experiment actually carried out by the inventors are shown below.

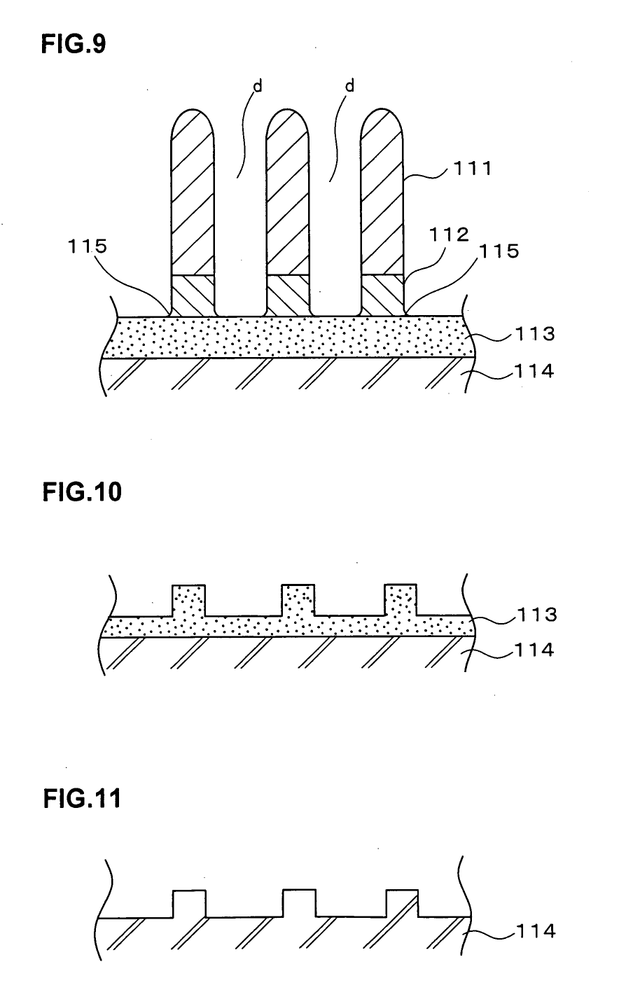

First, the state of the etched anti-reflection film 112 is shown in FIG. 9. Conditions of the etching are as follows. Note that a wafer W with a diameter of 300 millimeters was used.
Apparatus: Parallel plate type plasma etching apparatus
Frequency/power: Upper electrode 60 MHz/500W
   Lower electrode 2 MHz/600W
Etching gas: CF₄
Pressure: 13.3 Pa (100 mTorr)

As a result, the side wall portions 111 of the resist pattern are almost vertically cut with no projections and depressions.

Next, the state of the pattern after the etched TEOS oxide film 113 was etched is shown in FIG. 10, and the state of the pattern after the polysilicon film 114 was etched is shown in FIG. 11. Conditions of the etching for the TEOS oxide film 113 are as follows.
Apparatus: Parallel plate type plasma etching apparatus
Frequency/power: Upper electrode 60 MHz/2700W
   Lower electrode 2 MHz/3800W
Etching gas: C₄F6/Ar/O₂
Pressure: 4 Pa (30 mTorr)
   On the other hand, conditions of the etching for the polysilicon are as follows.
Apparatus: Parallel plate type plasma etching apparatus
Frequency/power: Upper electrode 60 MHz/250W
   Lower electrode 13.56 MHz/100W
Etching gas: HBr/O₂
Pressure: 4 Pa (30 mTorr)

As described above, according to this embodiment, it is possible to eliminate the projections and depressions and lines which appear on the resist pattern after the developing treatment to improve the striation, thereby improving LER on the pattern after the etching performed thereafter.

Although the surfactant is supplied onto the surface of the wafer W in implementing the shaping step of the resist pattern after the developing treatment in the above-described embodiment, a solvent dissolving the resist film may be used, in place of the surfactant, to perform the shaping step. In the case of using such a solvent, the solvent can be used similarly to the above-described surfactant.

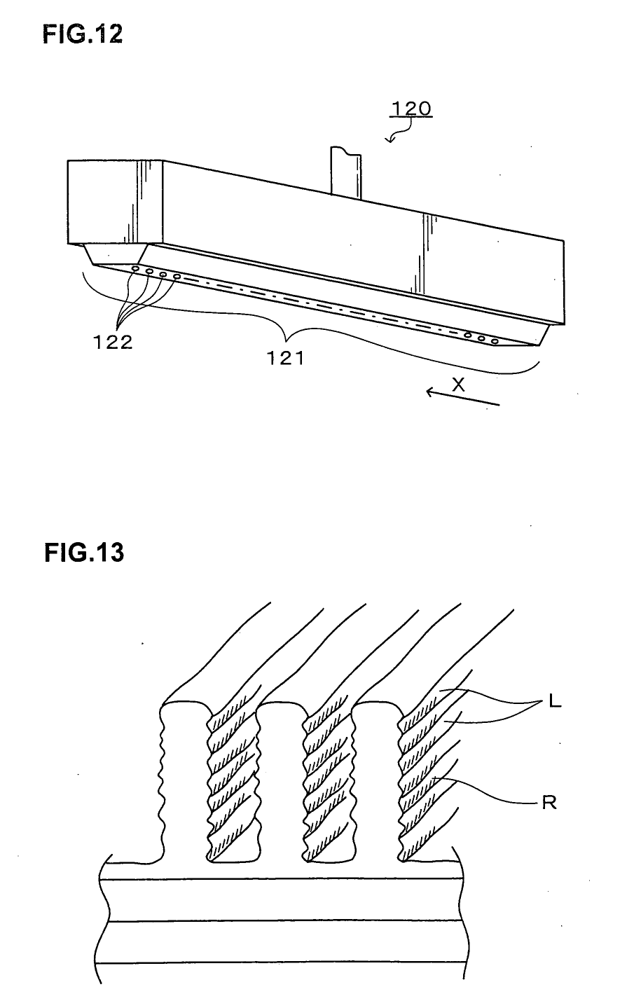

Further, in the case of using the solvent, the above-described shaping step may be performed by exposing the substrate to the vapor atmosphere of the solvent. In this case, for example, a solvent vapor supply nozzle 120 shown in FIG. 12 can be used in place of the above-described supply nozzle 101. This solvent vapor supply nozzle 120 has a shape having a length in the longitudinal direction longer than the diameter of the wafer W. The lower surface of the solvent vapor supply nozzle 120 is formed with a discharge portion 121 from one end portion to the other end portion in its longitudinal direction. The discharge portion 121 is formed with a plurality of circular discharge ports 122 along the longitudinal direction of the solvent vapor supply nozzle 120.

The solvent vapor supply nozzle 120 having such a configuration is preferably configured, similarly to the developing solution supply nozzle 83, to move, supported by the arm 81, on the rail 80. This makes it possible to scan the top of the wafer W and uniformly supply the solvent vapor to the wafer W.

It should be noted that the above-described embodiment is related to processing of the wafer, but the present invention is also applicable to other substrates such as an LCD substrate, a glass substrate for a photomask, and so on.

What is claimed is:

1. A substrate processing method in which a developing treatment is performed after exposure processing of a pattern, comprising:
a step of supplying a developing solution to a substrate which has been subjected to exposure processing of a pattern; and
a shaping step of shaping the shape of a resist pattern such that a side wall portion of the resist pattern after the developing treatment swells out to a groove side and a swell-out portion swelling out to the groove side and concavely curving with respect to the groove side is formed at a corner portion of a bottom of the resist pattern.

2. The substrate processing method as set forth in claim 1,
wherein the shaping is performed by swelling a resist film.

3. The substrate processing method as set forth in claim 2,
wherein said shaping step is performed after cleaning the developing solution supplied to the substrate during the developing treatment.

4. The substrate processing method as set forth in claim 3,
wherein the shaping is performed by mixing a surfactant or a liquid made by diluting the surfactant into the cleaning solution accumulated on the substrate, after cleaning the developing solution supplied to the substrate during the developing treatment.

5. The substrate processing method as set forth in claim 3,
wherein the shaping is performed by gradually replacing the cleaning solution accumulated on the substrate with a liquid made by diluting the surfactant, after cleaning the developing solution supplied to the substrate during the developing treatment.

6. The substrate processing method as set forth in claim 1,
wherein the shaping is performed by dissolving a resist film.

7. The substrate processing method as set forth in claim 6,
wherein the dissolving the resist film is performed by exposing the substrate to a vapor atmosphere of a solvent dissolving the resist film.

8. The substrate processing method as set forth in claim 6,
wherein the dissolving the resist film is performed by supplying a solvent dissolving the resist film to the substrate.
